(19) United States
(12) Patent Application Publication
(10) Pub. No.: US 2004/0049937 A1
(43) Pub. Date: Mar. 18, 2004

(54) Right handed tape measure

(76) Inventor: Mario Isaias Silva, Danbury, CT (US)

Correspondence Address: MARIO SILVA, 7 JOHN PERRY DRIVE, DANBURY, CT, 06811, US

(21) Appl. No.: 09/928,335

(22) Filed: Sep. 18, 2002

(51) Int. Cl. G01B 3/10

(52) U.S. Cl. 33/759

(57) ABSTRACT

My invention is an improvement over current measuring devices. My invention would allow for right-handed people to use their left hand to hold and pull the measuring device. The numbers would appear right side up to the holder and they would read in an ascending order from right to left. This would allow for ease of reading and manipulating a writing device to mark points or make annotations. The device could be in centimeters or inches as well as any length currently found in measuring devices.

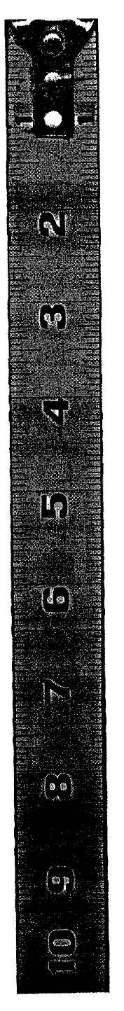

Gentlemen,

This is not an invention that I bring to you, but a simple modification on measurement tapes. The numbers on a standard measurement tape are inadequate for right handed people.

Isn't it amazing? Millions of people have been wasting time working with discomfort for so long! I'll explain. The majority of the population is right handed, right? To measure something, the right handed person holds the measurement tape with the right hand, hooks up the tape onto the piece to be measured, pulls it, and then has to change hands so that he can use his right hand to reach for the pencil in his pocket. Over and across his arm, he twists his body, and then he finally marks with the pencil what he has measured on his left side. Measuring like this I counted 8 seconds to complete the task.

With the “corrected” measurement tape with the numbers turned up side down, this same person can hold the tape on his left hand, hook the tape, pull it with the same hand, and mark the piece in 3 seconds.

The right-handed worker with the inadequate measurement tape wastes 5 seconds in every measurement, every day. It adds up to months and years working the wrong way, uncomfortable, crossing arms, twisting his body, stressing his muscles, and worst yet, wasting time and money.

Can you imagine how much time and discomfort you can save? There is an expression that we should always remember: TIME IS MONEY!

### DETAILED DESCRIPTION OF THE INVENTION

My invention is an improvement over current measuring instruments. The improvement can be readily adapted to all forms of current measuring tools including but not limited to, measuring tapes, metal blade tape with retractable blade, foldable wood, fiberglass flexible, and rulers. My tool would be ideal for right-handed workers. The numbers on the measuring device read from 1 ascending to the end of the tape in whatever graduation is desired. Since the number line reads from right to left the measuring device can be held in the left hand and extended to the desired point. The right-handed worker can then use his right hand to mark or write the desired point, and the numbers appear right side up to the person utilizing my invention.

1. What I claim as my invention is a right handed measuring device a graduated numbering line reading from right to left in an ascending manner said line will be right side up for ease of reading.
